(19) United States
(12) Patent Application Publication
(10) Pub. No.: US 2025/0199274 A1
(43) Pub. Date: Jun. 19, 2025

(54) REFLECTIVE MEMBER AND REFLECTIVE MODULE INCLUDING THE SAME

(71) Applicant: Samsung Electro-Mechanics Co., Ltd., Suwon-si (KR)

(72) Inventors: Deok Yeong JEONG, Suwon-si (KR); Jun Tae PARK, Suwon-si (KR); Jong Pil KIM, Suwon-si (KR); Seon Ho RYU, Suwon-si (KR)

(73) Assignee: Samsung Electro-Mechanics Co., Ltd., Suwon-si (KR)

(21) Appl. No.: 18/952,516

(22) Filed: Nov. 19, 2024

(30) Foreign Application Priority Data
Dec. 19, 2023 (KR) 10-2023-0185996

(51) Int. Cl. G02B 13/00; G02B 5/00; G02B 7/18; G02B 27/00

(52) U.S. Cl. CPC G02B 13/0065; G02B 5/003; G02B 7/1805; G02B 27/0018

(57) ABSTRACT

A reflective member is provided. The reflective member includes an incident surface on which light is incident, a reflective surface from which the incident light is reflected, an exit surface from which the light exits, and a light blocking portion that extends along an edge of at least one of the incident surface and the exit surface, wherein the light blocking portion includes a wave shape that is formed by a plurality of convex portions and a plurality of concave portions, and the wave shape has a plurality of wavelengths which respectively have sizes that change in an extension direction of the light blocking portion.

### CROSS-REFERENCE TO RELATED APPLICATIONS

This application claims the benefit under 35 USC § 119(a) of Korean Patent Application No. 10-2023-0185996 filed on Dec. 19, 2023, in the Korean Intellectual Property Office, the entire disclosure of which is incorporated herein by reference for all purposes.

### BACKGROUND

### 1. Field

The following description relates to a reflective member and a reflective module including the same.

### 2. Description of Related Art

Camera modules are being implemented in portable electronic devices, such as, but not limited to, smartphones. The thickness of portable electronic devices has decreased due to market demands, and accordingly, it is desirable that camera modules have a miniaturized form factor.

Apart from the demand for miniaturization of camera modules, there is also a demand for the improved performance of camera modules. Accordingly, operations, such as autofocusing (AF) and optical image stabilization (OIS), are added to camera modules. Accordingly, there is a limit to how much the size of camera modules may be reduced.

In other words, despite the demand for miniaturization of camera modules, it is difficult to reduce the size of camera modules, and accordingly, there are limits to reducing the thickness of portable electronic devices.

In order to solve this problem, camera modules including a plurality of lenses arranged in a length or width direction rather than in a thickness direction of portable electronic devices and a reflective member changing a path of light has been proposed.

Since these camera modules have a different structure from the typical camera modules, such as having a longer total track length and reflective members, the image quality thereof may deteriorate due to a flare phenomenon that did not occur in the typical camera modules.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a reflective member includes an incident surface on which light is incident; a reflective surface from which the incident light is reflected; an exit surface from which the reflected light exits; and a light blocking portion that extends along an edge of at least one of the incident surface and the exit surface, wherein the light blocking portion comprises a wave shape that is formed by a plurality of convex portions and a plurality of concave portions, and wherein the wave shape has a plurality of wavelengths which respectively have sizes that change in an extension direction of the light blocking portion.

The sizes of the plurality of wavelengths may be different from each other.

The convex portions and the concave portions may be repeatedly disposed to form a wave shape.

The light blocking portion may be formed of an opaque material.

The reflective member may further include a virtual first boundary line that corresponds to a region in which light is incident on the incident surface; and a virtual second boundary line that connects ends of the plurality of convex portions, wherein the first boundary line and the second boundary line may be disposed to be parallel to each other.

The reflective member may further include a virtual third boundary line that connects ends of the plurality of concave portions, wherein the third boundary line may be disposed outside of the incident surface compared to the first boundary line.

An amplitude of the plurality of wavelengths may be constant.

The reflective member may further include a virtual first boundary line which corresponds to a region in which light is incident on the incident surface, wherein the first boundary line may be disposed along a half point of an amplitude of the plurality of wavelengths.

The edge of the incident surface may include a first edge that is disposed in a length direction of the incident surface and a second edge that faces the first edge, and a portion of the light blocking portion that extends along the first edge may be bent inwardly of the incident surface.

A portion of the light blocking portion that extends along the second edge may be bent inwardly of the incident surface.

A period of the light blocking portion may be 0.3 mm or more and 2 mm or less.

In a general aspect, a reflective module includes a reflective member including an incident surface, a reflective surface, and an exit surface; and a holder on which the reflective member is mounted, wherein a light blocking portion may be disposed on at least one of the incident surface and the exit surface of the reflective member, wherein the light blocking portion may be configured to block a portion of at least one of the incident surface and the exit surface, wherein the light blocking portion includes a wave shape that is formed by a plurality of convex portions and a plurality of concave portions, and wherein the wave shape may have a plurality of wavelengths which have sizes that change in an extension direction of the light blocking portion.

The sizes of the plurality of wavelengths may be different from each other.

The convex portions and concave portions may be repeatedly disposed to form a wave shape.

The reflective module may include a virtual first boundary line that corresponds to a region in which light is incident on the incident surface; a virtual second boundary line that connects ends of the plurality of convex portions, wherein the first boundary line and the second boundary line may be disposed to be parallel to each other.

An amplitude of the plurality of wavelengths may be constant.

Other features and aspects will be apparent from the following detailed description, the drawings, and the claims.

### BRIEF DESCRIPTION OF DRAWINGS

FIG. 1 illustrates a perspective view of an example portable electronic device equipped with a camera module, in accordance with one or more embodiments.

FIG. 2 illustrates a schematic perspective view of an example camera module, in accordance with one or more embodiments.

FIG. 3 illustrates a schematic exploded perspective view of an example camera module, in accordance with one or more embodiments.

FIG. 4 illustrates a plan view of a lens provided in an example camera module, in accordance with one or more embodiments.

FIG. 5A and FIG. 5B illustrate schematic exploded perspective views of a reflective module, in accordance with one or more embodiments.

FIG. 6 illustrates a schematic assembled perspective view of a reflective module, in accordance with one or more embodiments.

FIG. 7 illustrates a schematic front view of a reflective module, in accordance with one or more embodiments.

FIG. 8 illustrates a light blocking device, in accordance with one or more embodiments.

FIG. 9, FIG. 10, and FIG. 11 are diagrams illustrating a light blocking device, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more example may provide a reflective member that prevents a flare phenomenon and a reflective module including the same.

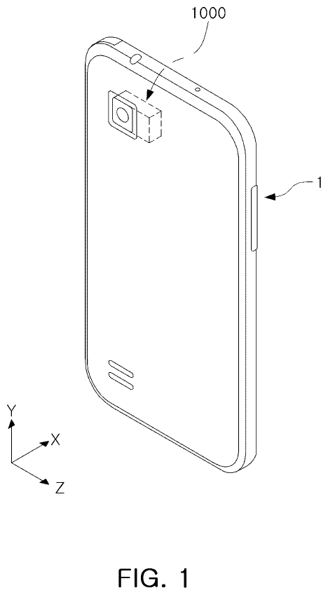

FIG. 1 illustrates a perspective view of an example portable electronic device equipped with a camera module, in accordance with one or more embodiments.

Referring to FIG. 1, a camera module 1000, in accordance with one or more embodiments, may be mounted on a portable electronic device 1. The portable electronic device 1 may be a portable electronic device, such as, as only examples, a mobile communication terminal, smartphone, or tablet personal computer (PC).

As illustrated in FIG. 1, the portable electronic device 1 is equipped with the camera module 1000 to image a subject.

In the one or more examples, the camera module 1000 includes a plurality of lenses. An optical axis (a Z-axis) of the plurality of lenses may be perpendicular to a thickness direction (an X-axis direction, i.e., a direction from a front surface of the portable electronic device to a rear surface thereof or vice versa).

In an example, the optical axis (the Z-axis) of the plurality of lenses provided in the camera module 1000 may be formed in the width or length direction of the portable electronic device 1.

Therefore, even if the camera module 1000 has operations such as autofocusing (AF), optical zoom (or zoom), optical image stabilization (OIS), and the like, a thickness of the portable electronic device 1 may not increase. Accordingly, it is possible to reduce the thickness of the portable electronic device 1.

The camera module 1000, in accordance with one or more embodiments, may be equipped with at least one of AF, zoom, and OIS operations.

Since the camera module 1000 that is equipped with the AF, zoom, and OIS operations should be equipped with various components, the size of the camera module may increase compared to a typical camera module.

If the size of the camera module 1000 increases, it may be difficult to reduce the thickness of the portable electronic device 1 on which the camera module 1000 is mounted.

For example, the camera module may include a plurality of lens groups to perform the zoom operation, and if the plurality of lens groups are arranged in the thickness direction of the portable electronic device, the thickness of the portable electronic device may increase according to the number of lens groups. Accordingly, unless the thickness of the portable electronic device is increased, a sufficient number of lens groups cannot be secured and zoom performance may weaken.

Additionally, in order to implement the AF, zoom, and OIS operations, an actuator should be installed to move a plurality of lens groups in the direction of the optical axis or in a direction, perpendicular to the optical axis, and here, if the optical axis (the Z axis) of the lens group is formed in the thickness direction of the portable electronic device, the actuator that moves the lens group should be installed in the thickness direction of the portable electronic device. In this example, the thickness of the portable electronic devices may increase.

However, in the camera module 1000, in accordance with one or more embodiments, the optical axis (the Z-axis) of the plurality of lenses is perpendicular to the thickness direction (the X-axis direction) of the portable electronic device 1, and thus, although the camera module 1000 including the AF, zoom, and OIS operations is mounted, the portable electronic device 1 may become thinner.

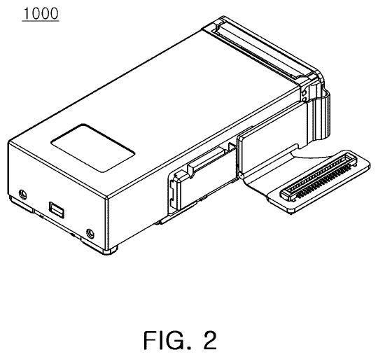

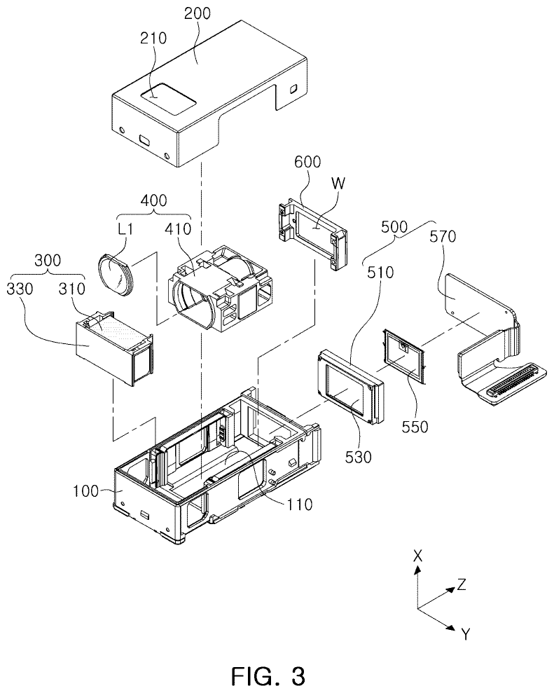

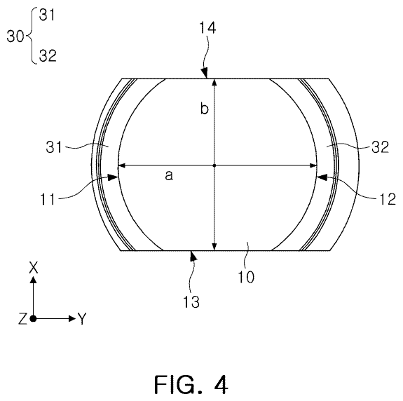

FIG. 2 is a schematic perspective view of an example camera module, in accordance with one or more embodiments, FIG. 3 is a schematic exploded perspective view of an example camera module, in accordance with one or more embodiments, and FIG. 4 is a plan view of a lens provided in an example camera module, in accordance with one or more embodiments.

First, referring to FIGS. 2 and 3, the camera module 1000 includes a housing 100, a reflective module 300, a lens module 400, an image sensor module 500, and a case 200.

The housing 100 may accommodate at least one of the reflective module 300, the lens module 400, and the image sensor module 500 therein. In an example, the reflective module 300, the lens module 400, and the image sensor module 500 may be disposed in an internal space of the housing 100 from a first side (for example, an object side) to a second side (for example, an imaging plane).

The housing 100 has an internal space to accommodate the reflective module 300, the lens module 400, and the image sensor module 500. However, in an example, the image sensor module 500 may be attached to the outside of the housing 100.

The housing 100 may have a box shape with an open top.

FIG. 3 illustrates an example embodiment in which the reflective module 300 is accommodated in the housing 100. However, unlike the example embodiment of FIG. 3, in an example, the reflective module 300 may be provided separately from the housing 100. In this example, one side of the housing 100 may be open to allow light transmitted from the reflective module 300 to pass therethrough. Additionally, in an example, the reflective module 300 disposed outside the housing 100 may be accommodated in a separate housing.

The case 200 is coupled to the housing 100 to cover an upper portion of housing 100. The case 200 includes an opening 210 through which light enters. A traveling direction of light incident through the opening 210 of the case 200 is changed based on the reflective module 300, and enters the lens module 400.

The reflective module 300 is configured to change the direction of light. In an example, the direction of light incident into the housing 100 may be changed to be directed to the lens module 400 through the reflective module 300. The reflective module 300 is disposed in front of the lens module 400.

The reflective module 300 includes a reflective member 310 and a holder 330 on which the reflective member 310 is mounted.

The reflective member 310 is configured to change the traveling direction of light. In a non-limited example, the reflective member 310 may be a mirror or prism that reflects light.

The lens module 400 includes a plurality of lenses through which light changed in traveling direction by the reflective member 310 passes and a lens barrel 410 that accommodates the plurality of lenses.

In FIG. 3, for convenience of description, only the lens L1 (hereinafter referred to as a first lens) disposed closest to an object side among the plurality of lenses is illustrated.

The image sensor module 500 includes a sensor housing 510, an infrared cutoff filter 530, an image sensor 550, and a printed circuit board (PCB) 570.

The infrared cutoff filter 530 may be mounted on the sensor housing 510. The infrared cutoff filter 530 may block light in an infrared region in the light passing through the lens module 400.

The PCB 570 is coupled to the sensor housing 510, and the PCB 570 is provided with the image sensor 550.

Light passing through the lens module 400 is received by the image sensor module 500 (e.g., the image sensor 550).

At least one lens among the plurality of lenses may have a non-circular planar shape. In an example, the first lens L1 is non-circular when viewed in the optical axis direction (the Z-axis direction). In a non-limited example, all of the plurality of lenses may have a non-circular planar shape.

Referring to FIG. 4, in a plane, perpendicular to the optical axis (the Z-axis), a length of the first lens L1 in a first direction (the X-axis direction), perpendicular to the optical axis (the Z-axis) may be shorter than a length of the first lens L1 in the second direction (the Y-axis direction), perpendicular to both the optical axis (the Z-axis) and the first direction (the X-axis direction).

In an example, the first lens L1 has a major axis (a) and a minor axis (b). A line segment connecting both sides of the first lens L1 in the first direction (the X-axis direction) while passing through the optical axis (the Z-axis) is the minor axis (b), and a line segment connecting both sides of the first lens L1 in the second direction (the Y-axis direction) while passing through the optical axis (the Z-axis) is the major axis (a). The major axis and minor axis are, perpendicular to each other, and the length of the major axis is longer than the length of the minor axis.

The first lens L1 includes an optical portion 10 and a flange portion 30.

The optical portion 10 may be a portion in which optical performance of the first lens L1 is demonstrated. In an example, light reflected from a subject may pass through the optical portion 10 and be refracted.

The optical portion 10 may have refractive power, and may have an aspherical shape.

The flange portion 30 may be configured to fix the first lens L1 to another component, for example, the lens barrel 410, or to another lens.

The flange portion 30 may extend from the optical portion 10, and may be formed integrally with the optical portion 10.

The optical portion 10 may be formed in a non-circular shape. For example, the optical portion 10 may be non-circular when viewed in the optical axis direction (the Z-axis direction). Referring to FIG. 4, in a plane, perpendicular to the optical axis (the Z-axis), a length of the optical portion 10 in the first direction (the X-axis direction), perpendicular to the optical axis (the Z-axis), is shorter than a length of the optical portion 10 in the second direction (the Y-axis direction), perpendicular to both the optical axis (the Z-axis) and the first direction (the X-axis direction).

The optical portion 10 includes a first edge 11, a second edge 12, a third edge 13 and a fourth edge 14.

When viewed in the optical axis direction (the Z-axis direction), the first edge 11 and the second edge 12 may each have an arc shape.

The second edge 12 is provided on the opposite side of the first edge 11. Additionally, the first edge 11 and the second edge 12 are located to face each other based on the optical axis (the Z-axis).

The fourth edge 14 is provided on the opposite side of the third edge 13. Additionally, the third edge 13 and the fourth edge 14 are located to face each other based on the optical axis (the Z-axis).

The third edge 13 and the fourth edge 14 connect the first edge 11 and the second edge 12, respectively. The third edge 13 and the fourth edge 14 are symmetrical based on the optical axis (the Z-axis) and may be formed parallel to each other.

When viewed in the optical axis direction (the Z-axis direction), the first edge 11 and the second edge 12 may include an arc shape, and the third edge 13 and the fourth edge 14 generally may include a straight shape.

The optical portion 10 has a major axis (a) and a minor axis (b). The line segment connecting the third edge 13 and the fourth edge 14 at the shortest distance while passing through the optical axis (the Z-axis) is the minor axis (b), and the line segment connecting the first edge 11 and the second edge 12 while passing through the optical axis (the Z-axis) and being perpendicular to the minor axis (b) is the major axis (a). The length of the major axis (a) is longer than the length of the minor axis (b).

The flange portion 30 extends in the second direction (the Y-axis direction) along the circumference of a portion of the optical portion 10. At least a portion of the flange portion 30 may be in contact with the internal surface of the lens barrel 410.

The flange portion 30 includes a first flange portion 31 and a second flange portion 32. The first flange portion 31 extends from the first edge 11 of the optical portion 10, and the second flange portion 32 extends from the second edge 12 of the optical portion 10.

The first edge 11 of the optical portion 10 may refer to a portion adjacent to the first flange portion 31, and the second edge 12 of the optical portion 10 may refer to a portion adjacent to the second flange portion 32.

The third edge 13 of the optical portion 10 may refer to one side of the optical portion 10 on which the flange portion 30 is not formed, and the fourth edge 14 of the optical portion 10 may refer to the other side of the optical portion 10 on which the flange portion 30 is not formed.

In an example, referring to FIG. 3, the first lens L1 is disposed so that one of the side surfaces facing in the first direction (the X-axis direction) faces a bottom surface 110 of the housing 100 and is disposed so that side surfaces facing in the second direction (the Y-axis direction) face an inner surface of the housing 100. That is, the first lens L1 is disposed so that the side surfaces facing in the first direction (the X-axis direction) face in the thickness direction (the X-axis direction) of the housing 100 and is disposed so that the side surfaces facing in the second direction (the Y-axis direction) faces in the width direction (the Y-axis direction) of the housing 100.

Since the length of the first lens L1 in the first direction (the X-axis direction) is shorter than the length in the second direction (the Y-axis direction), the thickness of the housing 100 may decrease.

In an example, referring to FIG. 3, the camera module 1000, in accordance with one or more embodiments, may further include a light blocking plate 600 disposed inside the housing 100.

As an example, the light blocking plate 600 may be disposed in the space between the lens module 400 and the image sensor module 500.

The light blocking plate 600 includes a window W in the form of an opening that allows light passing through the lens module 400 to be incident on the image sensor 550.

Since light passing through the lens module 400 is reflected on the internal surface of the housing 100 and/or the case 200, and unnecessary light may be incident on the image sensor 550, the light blocking plate 600 may be disposed between the lens module 400 and the image sensor module 500, thereby effectively suppressing a flare phenomenon.

The surface of the light blocking plate 600 may be surface-treated to scatter light.

The surface of the light blocking plate 600 may be formed to be rough. For example, the surface of the light blocking plate 600 may be formed to be rougher than the surface of the housing 100.

In an example, the surface of the light blocking plate 600 may be corroded to become rough.

A light absorption layer may be provided on a surface of the light blocking plate 600 to block unnecessary light. In an example, the surface of the light blocking plate 600 may have a lower reflectance than that of the surface of the housing 100. The light absorption layer may be black.

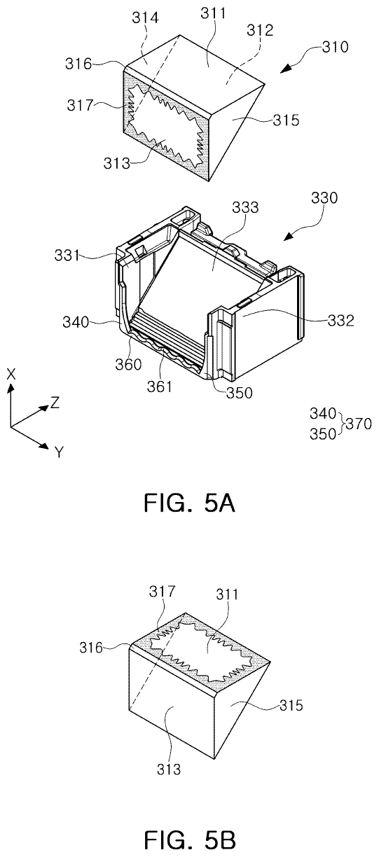

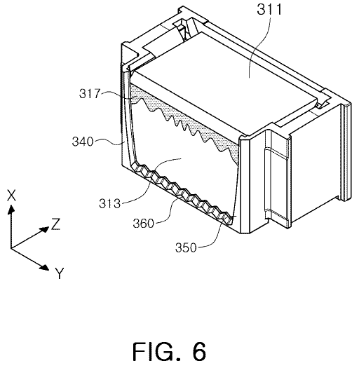

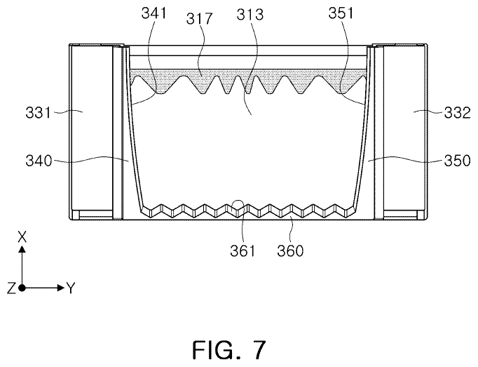

FIG. 5 is a schematic exploded perspective view of a reflective module, in accordance with one or more embodiments, FIG. 6 is a schematic assembled perspective view of a reflective module, in accordance with one or more embodiments, and FIG. 7 is a schematic front view of a reflective module, in accordance with one or more embodiments.

Referring to FIGS. 5 to 7, the reflective module 300 includes a reflective member 310 and a holder 330 on which the reflective member 310 is mounted.

The reflective member 310 is configured to change the traveling direction of light. In the present example embodiment, the reflective member 310 may be a prism. However, this is only an example, and the reflective member 310 may also be provided as a mirror.

The reflective member 310 may be in the form of a rectangular parallelepiped or a cube divided into two halves diagonally and includes an incident surface 311, a reflective surface 312, and an exit surface 313. The incident surface 311 is a surface on which light is incident on the reflective member 310, the reflective surface 312 is a surface from which light is reflected, and the exit surface 313 is a surface from which the light exits the reflective member 310.

The reflective member 310 includes three square-shaped surfaces and two triangular-shaped surfaces. For example, the incident surface 311, reflective surface 312, and exit surface 313 of the reflective member 310 are each rectangular, and both side surfaces 314 and 315 of the reflective member 310 are approximately triangular.

Since the edge in which the incident surface 311 and the exit surface 313 are connected is sharp, there is a risk of damage by impact. If the edge in which the incident surface 311 and the exit surface 313 are connected is damaged due to impact, a flare phenomenon may occur due to unintended reflection of light.

Accordingly, a chamfer portion 316 may be provided at a corner in which the incident surface 311 and the exit surface 313 of the reflective member 310 are connected to prevent the reflective member 310 from being damaged by impact, etc.

In an example, the chamfer portion 316 may be formed to have a preset angle with respect to the incident surface 311 and the exit surface 313. An angle between the chamfer portion 316 and the incident surface 311 and an angle between the chamfer portion 316 and the exit surface 313 may be obtuse angles.

The chamfer portion 316 may include a light blocking layer. In an example, the light blocking layer may be formed by attaching a light blocking film to the chamfer portion 316, or may be formed by painting the chamfer portion 316 with a light blocking paint.

A light blocking portion 317 may be provided on the incident surface 311 or the exit surface 313. The light blocking portion 317 is described below.

The holder 330 includes a first side wall 331 and a second side wall 332 surrounding both side surfaces of the reflective member 310. The first side wall 331 is disposed to surround one side surface 314 of the reflective member 310, and the second side wall 332 is disposed to surround the other side surface 315 of the reflective member 310.

Additionally, the holder 330 includes a mounting surface 333 on which the reflective member 310 is mounted. The mounting surface 333 is disposed between the first side wall 331 and the second side wall 332, and the mounting surface 333 may be an inclined surface.

In an example, the mounting surface 333 may be an inclined surface that is inclined at approximately 45° with respect to the optical axis (the Z-axis) of the plurality of lenses. The reflective surface 312 of the reflective member 310 is coupled to the mounting surface 333 of the holder 330.

In an example, light passing through the incident surface 311 is reflected by the reflecting surface 312 and passes through the exit surface 313.

However, if the light passing through the incident surface 311 is reflected from a portion (for example, the side surfaces 314 and 315 of the reflective member 310) other than the reflective surface 312, a flare phenomenon may occur.

Additionally, because not all of the light reflected from the reflective surface 312 is used to form an image, although light is reflected from the reflective surface 312, light not used to form an image may cause a flare phenomenon.

In the camera module 1000, in accordance with one or more embodiments, the holder 330 may cover a portion of the exit surface 313 of the reflective member 310, thereby preventing the flare phenomenon from occurring due to unnecessary light.

The holder 330 includes a cover portion 370 configured to cover a portion of the exit surface 313 of the reflective member 310. In an example, the cover portion 370 may be configured to cover both edges of the exit surface 313 of the reflective member 310.

The cover portion 370 includes a first cover portion 340 and a second cover portion 350.

The first cover portion 340 extends from the first side wall 331 in a direction (for example, the first axis direction (the X-axis direction)), perpendicular to the optical axis (the Z-axis), and the second cover portion 350 extends from the second side wall 332 in a direction (for example, the first axis direction (the X-axis direction)), perpendicular to the optical axis (the Z-axis). A distance between the first cover portion 340 and the second cover portion 350 based on the second axis direction (the Y-axis direction) may be close to each other in the first axis direction (the X-axis direction).

The first cover portion 340 and the second cover portion 350 each cover a portion of the exit surface 313 of the reflective member 310. The first cover portion 340 may be configured to cover one edge of the exit surface 313 of the reflective member 310, and the second cover portion 350 may be configured to cover the other edge of the exit surface 313 of the reflective member 310.

In an example, the first cover portion 340 may be disposed to surround a portion of the exit surface 313 of the reflective member 310 connected to one side surface 314 of the reflective member 310, and the second cover portion 350 may be disposed to surround a portion of the exit surface 313 of the reflective member 310 connected to the other side surface 315 of the reflective member 310.

The cover portion 370 may be configured such that an area thereof covering the exit surface 313 of the reflective member 310 increases toward the bottom surface 110 of the housing 100 (or toward a lower portion of the exit surface 313).

In an example, the first cover portion 340 and the second cover portion 350 may each be configured such that an area thereof covering the exit surface 313 of the reflective member 310 increases toward the bottom surface 110 of the housing 100.

The first cover portion 340 and the second cover portion 350 have surfaces 341 and 351 facing each other, respectively. The surfaces 341 and 351 of the first cover portion 340 and the second cover portion 350 facing each other each include a curved surface.

The surfaces 341 and 351 of the first cover portion 340 and the second cover portion 350 facing each other may be provided with an uneven portion or a light blocking layer to scatter light. For example, the uneven portion may be a surface that is subjected to a corrosion treatment to have a rough surface, and the light blocking layer may be formed by attaching a light blocking film or painting a light blocking paint on the surfaces of the first cover portion 340 and the second cover portion 350 facing each other.

Unnecessary light may be blocked by the first cover portion 340 and the second cover portion 350, and light may be scattered by the uneven portions provided in the surfaces 341 and 351 of the first cover portion 340 and the second cover portion 350 facing each other or unnecessary light may be blocked by the light blocking layer, and thus, a flare phenomenon may be suppressed.

In an example, the cover portion 370 may further include a third cover portion 360. The third cover portion 360 may be disposed to cover a portion of the exit surface 313 of the reflective member 310. In an example, the third cover portion 360 may be disposed to surround a portion of the exit surface 313 of the reflective member 310 connected to the reflective surface 312 of the reflective member 310.

The third cover portion 360 is configured to connect the first cover portion 340 to the second cover portion 350 and may extend in a direction (for example, the first direction (the X-axis direction)), perpendicular to the optical axis (the Z axis) from the end of the mounting surface 333 of the holder 330.

The third cover portion 360 includes a plurality of protrusions 361. The plurality of protrusions 361 may be disposed to be connected to each other to form a wave pattern. The plurality of protrusions 361 may be provided with uneven portions to scatter light or may be provided with a light blocking layer. In an example, the uneven portion may be a surface that is subjected to a corrosion treatment to have a rough surface, and the light blocking layer may be formed by attaching a light blocking film to the plurality of protrusions 361 or by painting the plurality of protrusions 361 with a light blocking paint.

Unnecessary light may be blocked by the third cover portion 360, and light may be scattered by the plurality of protrusions 361 of the third cover portion 360, so the flare phenomenon may be suppressed.

In the example camera module 1000, in accordance with one or more embodiments, by forming a light blocking structure in the holder 330 on which the reflective member 310 is mounted, a flare phenomenon caused by unnecessary light may be prevented.

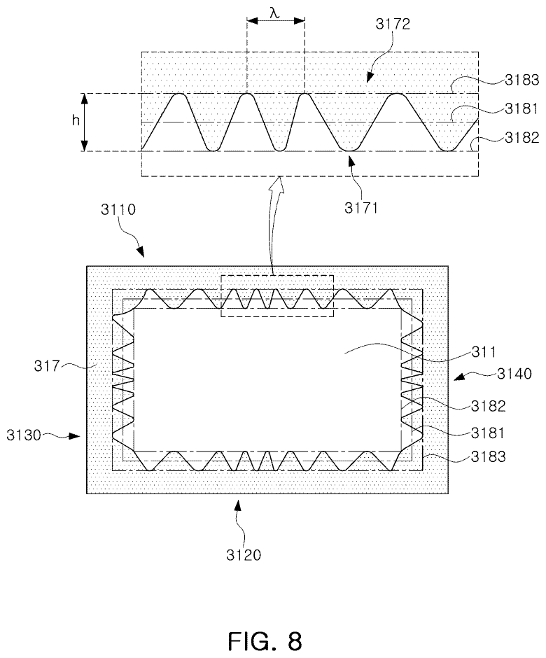

FIG. 8 illustrates a light blocking portion of a reflective member, in accordance with one or more embodiments.

Even if the light blocking structure is formed on the holder 330 on which the reflective member 310 is mounted, a flare phenomenon may occur due to light passing through the incident surface 311 of the reflective member 310 (for example, light passing through the edge of the incident surface 311) or light passing through the exit surface 313 (for example, light passing through the edge of the exit surface 313).

The light blocking portion 317 is provided on at least one of the incident surface 311 and the exit surface 313 of the reflective member 310. The light blocking portion 317 is configured to cover at least a portion of the incident surface 311 and the exit surface 313. The light blocking portion 317 may cover the edge of at least one of the incident surface 311 and the exit surface 313. In an example, the light blocking portion 317 may be formed of an opaque material. The light blocking portion 317 may be formed by applying opaque paint to the surface of the reflective member 310.

In the following description, for convenience of description, the light blocking portion 317 disposed on the incident surface 311 is mainly described, but the description thereof may also be applied to the light blocking portion 317 disposed on the exit surface 313.

The light blocking portion 317 may be disposed on the edge of the incident surface 311. The light blocking portion 317 may be disposed to extend along the edge of the incident surface 311. That is, the light blocking portion 317 may be disposed on the edge of the incident surface 311 to form a closed path.

The light blocking portion 317 may include a convex portion 3171 and a concave portion 3172.

The convex portion 3171 may refer to a portion that protrudes toward the inside of the incident surface 311, and the concave portion 3172 may refer to a portion that is recessed toward the outside of the incident surface 311.

The convex portion 3171 and the concave portion 3172 may be disposed to be connected and may be alternately disposed. A plurality of convex portions 3171 and a plurality of concave portions may be disposed, and each of the plurality of convex portions 3171 and the plurality of concave portions 3172 may be alternately and repeatedly arranged to form a wave shape. That is, the light blocking portion 317 may have a wave shape that is formed by connecting the convex portion 3171 and the concave portion 3172 to each other. Since a portion of the light blocking portion 317 is in the shape of a wave disposed along the edge of the incident surface 311, the light blocking portion 317 may have an amplitude h and a wavelength λ.

In an example, the amplitude h of the light blocking portion 317 may be constant along the edge of the incident surface 311.

The incident surface 311 may have an effective surface. In an example, the effective surface may refer to a region in which light is illuminated on the incident surface 311. Referring to FIG. 8, the effective surface may refer to the inside of a first boundary line 3181.

The first boundary line 3181 may be a virtual line corresponding to the region of the incident surface 311 in which light is illuminated. The first boundary line 3181 may refer to a closed path. With reference to FIG. 8, the first boundary line 3181 may extend along the edge of the incident surface 311, but the shape of the first boundary line 3181 may vary. That is, when a separate member is disposed in front of the incident surface 311 to cover a portion of the incident surface 311, the first boundary line 3181 may be determined along a region of the incident surface 311 not covered by the separate member. That is, the shape of the first boundary line 3181, which is a closed path, may be determined by the region in which light is illuminated on the incident surface 311. For example, the shape of the first boundary line 3181 may be square, circular, or triangular.

The amplitude h of the light blocking portion 317 may be maintained constant along the first boundary line 3181. The first boundary line 3181 may be disposed along a half point of the amplitude h of the light blocking portion 317. That is, the shortest distance from the first boundary line 3181 to the end of the convex portion 3171 may be the same as the shortest distance from the first boundary line 3181 to the end of the concave portion 3172. In a non-limiting example, the amplitude of the light blocking portion 317 may be, for example, 0.1 mm or more and 1 mm or less.

A virtual line connecting the ends of the plurality of convex portions 3171 may be referred to as a second boundary line 3182. The second boundary line 3182 may be disposed to be parallel to the first boundary line 3181. The second boundary line 3182 may be disposed relatively inside the incident surface 311 compared to the first boundary line 3181.

Additionally, a virtual line connecting the ends of the plurality of concave portions 3172 may be referred to as a third boundary line 3183. The third boundary line 3183 may be disposed to be parallel to the first boundary line 3181. The third boundary line 3183 may be disposed relatively outside of the incident surface 311 compared to the first boundary line 3181.

That is, the first boundary line 3181, the second boundary line 3182, and the third boundary line 3183 may be virtual lines extending to be parallel to each other. Additionally, the second boundary line 3182 and the third boundary line 3183 may be disposed on the opposite sides of each other with the first boundary line 3181 in between. The second boundary line 3182, the first boundary line 3181, and the third boundary line 3183 may be sequentially arranged to be spaced apart from each other.

In an example, a distance between the first boundary line 3181 and the second boundary line 3182 may be the same as a distance between the first boundary line 3181 and the third boundary line 3183.

The wavelength λ of the light blocking portion 317 may change. The wavelength λ of the light blocking portion 317 may change in the extension direction of the light blocking portion 317. That is, the light blocking portion 317 may have a plurality of wavelengths λ. Each of the plurality of wavelengths λ may change along the first boundary line 3181. In addition, the plurality of wavelengths λ of the light blocking portion 317 may have different sizes. For example, the wavelength λ of the light blocking portion 317 may be in the range of 0.3 mm or more and 2 mm or less, and the size of each of the plurality of wavelengths λ may be different from each other.

A portion of light incident on the reflective member 310 may be reflected by the light blocking portion 317. In this example, the reflected light may be scattered.

When light is reflected from a plurality of regions of the light blocking portion 317, the reflected light beams may be scattered in different directions. Flare may be reduced by scattering the reflected light beams in different directions and through destructive interference between the scattered light beams.

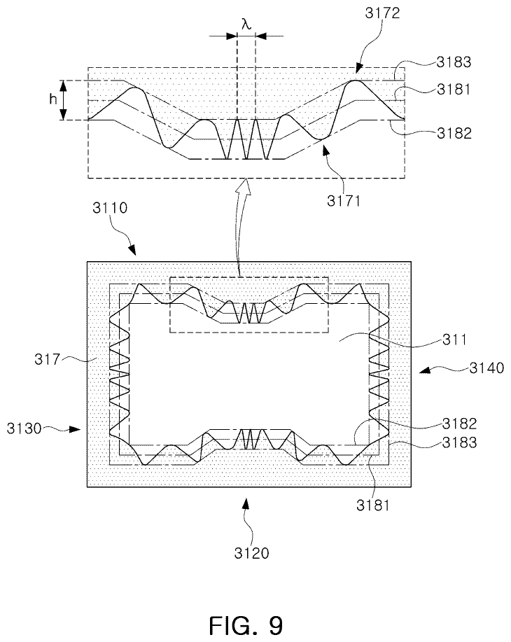

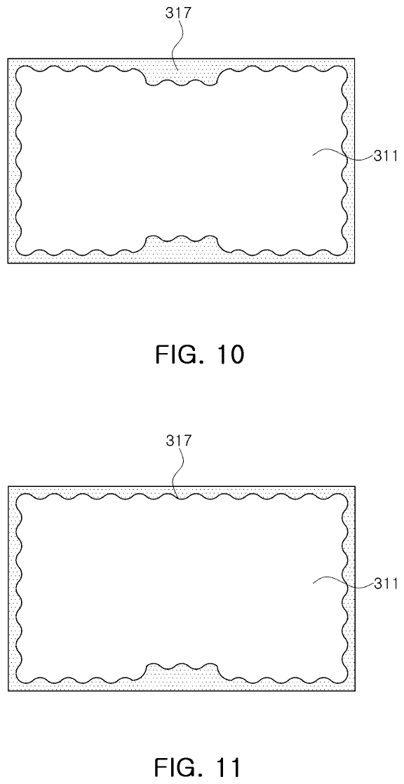

FIG. 9 is a modified example of the light blocking portion 317, in accordance with one or more embodiments. Hereinafter, description of the same contents as those of the reflective member 310 according to, in accordance with one or more embodiments described above may be omitted.

The first boundary line 3181 may have a rectangular structure in which a portion thereof is depressed. That is, a region formed by the first boundary line 3181 may have a structure in which a portion thereof is recessed inwardly of the incident surface 311.

Referring to FIG. 9, the incident surface 311 may include a first edge 3110 disposed in the length direction of the incident surface 311, a second edge 3120 facing the first edge 3110, a third edge 3130 connecting the first edge 3110 to the second edge 3120, and a fourth edge 3140 connecting the first edge 3110 to the second edge 3120 and facing the third edge 3130.

A portion of the first boundary line 3181 extending along the first edge 3110 and the second edge 3120 may include a bent region. Since the second boundary line 3182 and the third boundary line 3183 are arranged in parallel along the first boundary line 3181, the second boundary line 3182 may also have a structure in which a portion thereof is recessed inwardly of the incident surface 311. Accordingly, a portion of the light blocking portion 317 extending along the first edge 3110 may be bent inwardly of the incident surface 311, and a portion of the light blocking portion 317 extending along the second edge 3120 may also be bent inwardly of the incident surface 311.

FIGS. 10 and 11 illustrate another modified example of the light blocking portion 317. Hereinafter, description of the same contents as those of the reflective member 310, in accordance with one or more embodiments described above may be omitted.

Similar to the previously described example embodiments, the light blocking portion 317 may include a wave shape. However, according to the example embodiment of FIGS. 10 and 11, the amplitude h and wavelength λ of the wave may be constant.

The light blocking portion 317 may be disposed along the edge of the incident surface 311. The incident surface 311 may include the first edge 3110 disposed along the length direction of the incident surface 311, the second edge 3120 facing the first edge 3110, the third edge 3130 connecting the first edge 3110 to the second edge 3110, and the fourth edge 3140 connecting the first edge 3110 to the second edge 3120 and facing the third edge 3130.

A portion of the light blocking portion 317 extending along the first edge 3110 or the second edge 3120 may include a region that is bent inwardly of the incident surface 311.

The reflective member and the reflective module including the same, in accordance with one or more embodiments, e may prevent a flare phenomenon.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A reflective member, comprising:
an incident surface on which light is incident;
a reflective surface from which the incident light is reflected;
an exit surface from which the reflected light exits; and
a light blocking portion that extends along an edge of at least one of the incident surface and the exit surface,
wherein the light blocking portion comprises a wave shape that is formed by a plurality of convex portions and a plurality of concave portions, and
wherein the wave shape has a plurality of wavelengths which respectively have sizes that change in an extension direction of the light blocking portion.

2. The reflective member of claim 1, wherein the sizes of the plurality of wavelengths are different from each other.

3. The reflective member of claim 1, wherein the convex portions and the concave portions are repeatedly disposed to form a wave shape.

4. The reflective member of claim 1, wherein the light blocking portion is formed of an opaque material.

5. The reflective member of claim 1, further comprising:
a virtual first boundary line that corresponds to a region in which light is incident on the incident surface; and
a virtual second boundary line that connects ends of the plurality of convex portions,
wherein the first boundary line and the second boundary line are disposed to be parallel to each other.

6. The reflective member of claim 5, further comprising:
a virtual third boundary line that connects ends of the plurality of concave portions,
wherein the third boundary line is disposed outside of the incident surface compared to the first boundary line.

7. The reflective member of claim 1, wherein an amplitude of the plurality of wavelengths is constant.

8. The reflective member of claim 1, further comprising:
a virtual first boundary line which corresponds to a region in which light is incident on the incident surface,
wherein the first boundary line is disposed along a half point of an amplitude of the plurality of wavelengths.

9. The reflective member of claim 1, wherein:
the edge of the incident surface comprises a first edge that is disposed in a length direction of the incident surface and a second edge that faces the first edge, and
a portion of the light blocking portion that extends along the first edge is bent inwardly of the incident surface.

10. The reflective member of claim 9, wherein a portion of the light blocking portion that extends along the second edge is bent inwardly of the incident surface.

11. The reflective member of claim 1, wherein a period of the light blocking portion is 0.3 mm or more and 2 mm or less.

12. A portable electronic device comprising the reflective member of claim 1.

13. A reflective module, comprising:
a reflective member comprising an incident surface, a reflective surface, and an exit surface; and
a holder on which the reflective member is mounted,
wherein a light blocking portion is disposed on at least one of the incident surface and the exit surface of the reflective member,
wherein the light blocking portion is configured to block a portion of at least one of the incident surface and the exit surface,
wherein the light blocking portion comprises a wave shape that is formed by a plurality of convex portions and a plurality of concave portions, and
wherein the wave shape has a plurality of wavelengths which have sizes that change in an extension direction of the light blocking portion.

14. The reflective module of claim 13, wherein the sizes of the plurality of wavelengths are different from each other.

15. The reflective module of claim 13, wherein the convex portions and concave portions are repeatedly disposed to form a wave shape.

16. The reflective module of claim 13, further comprising:
a virtual first boundary line that corresponds to a region in which light is incident on the incident surface; and
a virtual second boundary line that connects ends of the plurality of convex portions,
wherein the first boundary line and the second boundary line are disposed to be parallel to each other.

17. The reflective module of claim 13, wherein an amplitude of the plurality of wavelengths is constant.

18. A portable electronic device comprising the reflective module of claim 13.
